(19) United States
(12) Patent Application Publication
(10) Pub. No.: US 2026/0264451 A1
(43) Pub. Date: Sep. 10, 2026

(54) RUBBER MIXTURE AND TIRE

(71) Applicant: Continental Reifen Deutschland GmbH, Hannover (DE)

(72) Inventors: Fabian Schax, Seelze (DE); Norbert Müller, Nienhagen (DE); Catarina Nardi Tironi, Hannover (DE); Nadia Lhuillier, Garbsen (DE); Ana-Maria Lepadatu, Hannover (DE)

(73) Assignee: Continental Reifen Deutschland GmbH, Hannover (DE)

(21) Appl. No.: 19/165,709

(22) PCT Filed: Mar. 12, 2024
(86) PCT No.: PCT/EP2024/056556

§ 371 Date: Sep. 16, 2025

(30) Foreign Application Priority Data
Mar. 31, 2023 (EP) 23165810.5

(51) Int. Cl. B60C 1/00; C08K 3/04; C08K 3/06; C08K 3/22; C08K 3/36; C08L 9/06

(52) U.S. Cl. CPC B60C 1/0016; C08K 3/04; C08K 3/06; C08K 3/22; C08K 3/36; C08L 9/06; C08K 2003/2296; C08L 2205/02; C08L 2207/324

(57) ABSTRACT

A sulfur-crosslinkable rubber mixture, especially for the tread of pneumatic vehicle tires, containing at least the following constituents: at least one diene rubber, 5 to 70 phr (parts by weight based on 100 parts by weight of all rubbers in the mixture) of at least one terpene resin based to an extent of more than 95% on biologically renewable raw materials, 1 to 40 phr of at least one liquid polybutadiene which is organosilicon-modified and has an average molecular weight M_{w} by GPC of 500 to 18 000 g/mol and 40-350 phr of at least one filler.

The invention relates to a sulfur-crosslinkable rubber mixture, in particular for the tread of pneumatic vehicle tires.

The invention further relates to a pneumatic vehicle tire having at least one component made of such a sulfur-vulcanized rubber mixture.

Since the running properties of a tire, especially a pneumatic vehicle tire, depend to a great extent on the rubber composition of the tread, particularly high demands are placed on the composition of the tread mixture. There are trade-offs between most of the known tire properties, such as wet grip characteristics, braking characteristics, handling characteristics, rolling resistance, winter properties, abrasion characteristics and tear properties. Various attempts have already been made to positively influence the properties of the tire through the variation of the polymer components, the fillers and the other admixtures in the tread mixture.

In addition to the abovementioned objectives with regard to the mixture and vulcanizate properties, efforts are now being made in rubber mixtures for vehicle tires to employ materials which are as sustainable and environmentally friendly as possible, to reduce dependence on fossil raw materials and to minimize the emission of greenhouse gases. One path to sustainable products is via the recycling of old products which are no longer needed, for example recycling of old tires, wherein the recycled material is recycled into the production of new tires. Another way to improve the sustainability of products is the use of substances from renewable raw materials as additives for rubber mixtures. Such additives from renewable raw materials include vegetable oils, resins based on renewable raw materials or rice husk silica. The latter is silica produced from biobased sodium silicate from rice husk ash.

EP 3 350 259 B1 and EP 3 350 260 B1 disclose rubber compounds for tire treads having a good profile of properties and containing a terpene-styrene resin and a non-functionalized liquid polybutadiene.

U.S. Pat. No. 10,654,995 B2 describes a rubber mixture for tire treads containing a resin based on α-pinene and a liquid polybutadiene end-functionalized with hydroxyl groups.

The problem addressed by the invention is that of providing sustainable rubber mixtures for the treads of pneumatic vehicle tires which result in good rolling resistance coupled with good structural durability in the tires.

This object is achieved in accordance with the invention by a sulfur-crosslinkable rubber mixture, especially for the tread of pneumatic vehicle tires, comprising at least the following constituents:
at least one diene rubber,
5 to 70 phr (parts by weight based on 100 parts by weight of all rubbers in the mixture) of at least one terpene resin based to an extent of more than 95% on biologically renewable raw materials,
1 to 40 phr of at least one liquid polybutadiene which is organosilicon-modified and has an average molecular weight M_{w} by GPC of 500 to 18 000 g/mol and
40-350 phr of at least one filler.

It has now been found that, surprisingly, this specific combination of at least one terpene resin based to an extent of more than 95% on biologically renewable raw materials with a liquid polybutadiene, which is organosilicon-modified and has an average molecular weight M_{w} by GPC of 500 to 18 000 g/mol, in the specified amounts in silica-containing diene rubber mixtures leads to a low maximum loss factor tan δₘₐₓ at 55° C. and a low tan δ (10%) by RPA which is correlated with a low rolling resistance when used in a tire tread. The mixtures according to the invention simultaneously show good stress-strain properties, such as a high tensile strength and a high breaking elongation, which are associated with improved structural durability. Use of the rubber mixture according to the invention in treads of pneumatic vehicle tires thus results in a pneumatic vehicle tire which features good sustainability coupled with good rolling resistance and good durability.

The unit “phr” (parts per hundred parts of rubber by weight) used in this document is the standard unit of amount for mixture formulations in the rubber industry. The dosage of the parts by weight of the individual substances is always based here on 100 parts by weight of the total mass of all solid rubbers present in the mixture.

The term “a terpene resin based on more than 95% of biologically renewable raw materials” is in the context of the present invention to be understood as meaning a terpene resin which is physically produced from renewable raw materials as the source, wherein vegetable sources in particular are preferred.

According to the invention, the rubber mixture comprises at least one diene rubber. Diene rubbers are rubbers formed by polymerization or copolymerization of dienes and/or cycloalkenes and thus have C═C double bonds either in the main chain or in the side groups.

The diene rubber(s) is/are preferably selected from the group consisting of natural polyisoprene (NR), synthetic polyisoprene (IR), epoxidized polyisoprene (ENR), butadiene rubber (BR), butadiene-isoprene rubber, styrene-butadiene rubber (SBR), in particular solution-polymerized styrene-butadiene rubber (SSBR) and emulsion-polymerized styrene-butadiene rubber (ESBR), styrene-isoprene rubber, liquid rubbers having a molecular weight M_{w} of more than 20 000 g/mol, halobutyl rubber, polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, styrene-isoprene-butadiene terpolymer, hydrogenated acrylonitrile butadiene rubber and hydrogenated styrene-butadiene rubber.

Nitrile rubber, hydrogenated acrylonitrile-butadiene rubber, chloroprene rubber, butyl rubber, halobutyl rubber or ethylene-propylene-diene rubber in particular are used in the production of industrial rubber articles, such as belts, drive belts, and hoses, and/or footwear soles. The mixture compositions known to those skilled in the art for these rubbers, which are specific in terms of fillers, plasticizers, vulcanization systems, and additives, are used with preference here.

In a particularly preferred embodiment of the invention the diene rubber(s) is/are selected from the group consisting of natural polyisoprene (NR), synthetic polyisoprene (IR), butadiene rubber (BR), solution-polymerized styrene-butadiene rubber (SSBR), and emulsion-polymerized styrene-butadiene rubber (ESBR). A rubber mixture of this kind is especially suitable for the tread of vehicle tires. Natural polyisoprene is understood to mean rubber that can be obtained by harvesting from sources such as rubber trees (Hevea brasiliensis) or non-rubber tree sources (for example guayule or dandelion (e.g. Taraxacum koksaghyz)). Natural polyisoprene (NR) is understood as meaning nonsynthetic polyisoprene.

The rubber mixture according to the invention contains 5 to 70 phr, preferably 20 to 60 phr, particularly preferably 30 to 50 phr, of at least one terpene resin based to an extent of more than 95% on biologically renewable raw materials. It is also possible to use two or more different terpene resins in the mixture. It is preferable when the terpene resin is based to an extent of 100% on biologically renewable raw materials.

Terpene resins which are based to an extent of more than 95% on biologically renewable raw materials are obtainable for example from raw materials generated in the production of aromas from orange peel. However, it is preferable when the terpene resin is based on byproducts generated in pulp production from softwoods. Such byproducts are commercially available in large quantities and may be upgraded into terpene resins on an industrial scale.

In a preferred development of the invention the terpene resin is not based on limonene.

The terpene resin is preferably based on α- and β-pinene. Such terpene resins are producible from byproducts generated in pulp production from softwoods.

The terpene resin which is based to an extent of more than 95% on biologically renewable raw materials preferably has an average molecular weight M_{w} by GPC of 800 to 1500 g/mol. Such terpene resins are readily processible and lead to good tear properties.

In a preferred development of the invention the terpene resin has a softening point of 100° C. to 140° C., preferably 110° C. to 130° C.

To achieve good braking characteristics of the tire, whose tread is composed of the rubber mixture according to the invention, the terpene resin has a glass transition temperature Tg according to DSC of 50° C. to 100° C., preferably of 50° C. to 80° C.

Terpene resins employable according to the invention may include for example those of the type Sylvatraxx® 8115 and Sylvatraxx® 8125 from Kraton Chemicals SAS. These are based to an extent of 100% on biologically renewable raw materials and not on limonene.

The rubber mixture according to the invention contains 1 to 40 phr, preferably 2 to 17 phr, of at least one liquid polybutadiene which is organosilicon modified and has an average molecular weight M_{w} by GPC of 500 to 18 000 g/mol. The abbreviation M_{w} represents the weight-average molecular weight of polymers. The weight average M_{w} is determined by gel permeation chromatography (GPC with polybutadiene standard). The value range of the M_{w} from 500 to 18 000 g/mol implies that the polybutadiene is liquid at room temperature. For the sake of simplicity, therefore, in the context of the present invention, the shortened expression “liquid polybutadiene” is also used. The indicated M_{w} value is based on the polybutadiene including the organosilicon modification.

The liquid polybutadiene may be organosilicon-modified terminally and/or along the chain.

It is preferable when the liquid polybutadiene has been modified with at least one radical of formula I):

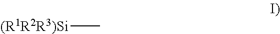

wherein R¹, R², R³ in the structures may be the same or different and may be selected from linear or branched alkoxy, cycloalkoxy, alkyl, cycloalkyl or aryl groups having 1 to 20 carbon atoms and wherein the radical of formula I) is attached to the polymer chain of the polybutadiene directly or via a bridge and wherein the bridge consists of a saturated or unsaturated carbon chain which may also contain cyclic and/or aliphatic and/or aromatic elements and heteroatoms in or on the chain. Such a modification results in advantages in the rolling resistance of tires.

In a preferred development of the invention the liquid polybutadiene is terminally modified with a triethoxysilane group. These polybutadienes are easy to manufacture and are available on the market on an industrial scale, for example under the name Polyvest® EP ST-E 60 from Evonik.

To improve winter properties and rolling resistance the liquid polybutadiene which is organosilicon-modified has a glass transition temperature T_{g} by DSC of −85° C. to −30° C. Determination of the glass transition temperature (T_{g}) of the polymers is carried outby dynamic scanning calorimetry (DSC according to DIN 53765: 1994-03 or ISO 11357-2: 1999-03, calibrated DSC with cryogenic apparatus, calibration according to apparatus type and manufacturer's specifications, sample in aluminum crucible with aluminum lid, cooling to temperatures below −120° C. at 10° C./min).

The liquid polybutadiene preferably has a vinyl content (content of 1,2-bonded butadiene based on the monomers of the polymer chain of the polybutadiene) of 5% to 30%, particularly preferably 10% to 25%. The liquid polybutadiene preferably has a 1,4-trans content of 40% to 75% (based on the monomers of the polymer chain of the polybutadiene). The cis content of the liquid polybutadiene is preferably 5% to 30% (based on the monomers of the polymer chain of the polybutadiene).

The rubber mixture contains 40 to 350 phr of at least one filler. This may comprise fillers such as carbon blacks, silicas, aluminosilicates, chalk, starch, magnesium oxide, titanium dioxide or rubber gels in customary amounts, wherein the fillers may be used in combination. Additionally conceivable are carbon nanotubes (CNTs, including discrete CNTs, so-called hollow carbon fibers (HCFs) and modified CNTs containing one or more functional groups, such as hydroxyl, carboxyl and carbonyl groups). Graphite and graphenes and so-called “carbon-silica dual-phase filler” are employable as filler.

It is also possible to employ different fillers in the mixture.

If carbon black is present in the rubber mixture, it is possible to use any of the carbon black types known to the person skilled in the art. Preference is given, however, to using a carbon black having an iodine adsorption number according to ASTM D 1510 of 30 to 180 g/kg, preferably 30 to 130 kg/g, and a DBP number according to ASTM D 2414 of 80 to 200 ml/100 g, preferably 100 to 200 ml/100 g, more preferably 100 to 180 ml/100 g. For application in the vehicle tire this achieves particularly good rolling resistance indicators (rebound resilience at 70° C.) coupled with good remaining tire properties.

To reduce rolling resistance it has been found to be advantageous when the rubber mixture contains 20 to 200 phr of silica as filler. Other fillers, such as carbon black, are additionally present in the mixture with the result that a proportion of 40 to 350 phr of total filler is present in the mixture.

It is possible to use a wide variety of different silicas, such as “low-surface area” or highly dispersible silica, including in a mixture. It is particularly preferable to employ a finely divided, precipitated silica having a CTAB surface area (according to ASTM D 3765) of 30 to 350 m²/g, preferably of 110 to 250 m²/g. Employable silicas include both conventional silicas, such as those of the VN3 type (trade name) from Evonik, or highly dispersible silicas known as HD silicas (e.g. Ultrasil 7000 from Evonik). Silicas produced from rice husk ash are also suitable.

For improvement of processibility and for binding of the silica to the diene rubber in silica-containing mixtures, preference is given to using at least one silane coupling agent in amounts of 1-15 phf (parts by weight, based on 100 parts by weight of silica) in the rubber mixture. The silane coupling agents may also be used as mixtures.

The expression phf (parts per hundred parts of filler by weight) used in this document is the unit of quantity for coupling agents for polar fillers which is commonly used in the rubber industry. In the context of the present application phf refers to the silica present, meaning that any other fillers present, such as carbon black, are not included in the calculation of the amount of silane coupling agent.

The silane coupling agents react with the surface silanol groups of the silica or other polar groups during the mixing of the rubber/the rubber mixture (in situ) or in the context of a pretreatment (premodification) performed before addition of the filler to the rubber. Silane coupling agents that may be used here include all silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that after cleavage can optionally undergo a chemical reaction with the double bonds of the polymer. The latter group may for example comprise the following chemical groups: —SCN, —SH, —NH₂ or —Sₓ— (where x=2-8). Silane coupling agents that may be used thus include for example 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of sulfides having 1 to 8 sulfur atoms with varying contents of the various sulfides. TESPT may for example also be added as a mixture with industrial carbon black (trade name X50S from Degussa). Blocked mercaptosilanes as known for example from WO 99/09036 may also be used as silane coupling agent. It is also possible to use silanes as described in WO 2008/083241 A1, WO 2008/083242 A1, WO 2008/083243 A1, and WO 2008/083244 A1. It is possible to use for example silanes sold under the NXT® name in a number of variants by Momentive, USA, or those sold under the VP Si 363 name by Evonik Industries. Also employable are “silated core polysulfides” (SCPs, polysulfides with a silylated core), which are described for example in US 20080161477 A1 and EP 2 114 961 B1.

It is preferable when at least one silane coupling agent in the rubber mixture is 3,3′-bis(triethoxysilylpropyl)disulfide (TESPD).

The rubber mixture according to the invention may also contain different plasticizers. These are preferably present in the mixture in amounts of 5 to 50 phr, particularly preferably of 5 to 30 phr. These plasticizers do not include organosilicon-modified, liquid polybutadienes.

The plasticizer(s) are preferably selected from the group consisting of plasticizers from renewable raw materials such as rapeseed oil or sunflower oil, mineral oils, phosphoric esters such as tri-(2-ethylhexyl)phosphate and liquid polymers having a weight-average molecular weight distribution M_{w} by GPC of 60 000 g/mol or less.

When using mineral oil this is preferably selected from the group consisting of DAE (distillated aromatic extracts), RAE (residual aromatic extract), TDAE (treated distillated aromatic extracts), MES (mild extracted solvents), white mineral oils and naphthenic oils, wherein RAE is particularly preferred.

In an advantageous development of the invention the plasticizer employed is a vegetable oil. This is an advantage from both an environmental and economic standpoint and offers advantageous properties in tires. It is particularly preferable when the vegetable oil is rapeseed oil.

The rubber mixture may further contain customary additives in customary parts by weight which are added preferably in at least one preliminary mixing stage during the production of said mixture. These additives include
a) aging inhibitors, such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), and 2,2,4-trimethyl-1,2-dihydroquinoline (TMQ),
b) activators, for example zinc oxide and fatty acids (e.g. stearic acid) or zinc complexes, for example zinc ethylhexanoate,
c) waxes,
d) mastication aids, for example 2,2′-dibenzamidodiphenyl disulfide (DBD), and
e) processing aids, for example fatty acid salts, for example zinc soaps, and fatty acid esters and derivatives thereof.

The proportion of the total amount of further additives is 3 to 150 phr, preferably 3 to 100 phr, and more preferably 5 to 80 phr.

The vulcanization of the rubber mixture is carried out in the presence of sulfur and/or sulfur donors with the aid of vulcanization accelerators, it being possible for some vulcanization accelerators to act simultaneously as sulfur donors. The accelerator is selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators.

It is preferable to use a sulfenamide accelerator selected from the group consisting of N-cyclohexyl-2-benzothiazolesulfenamide (CBS) and/or N,N-dicyclohexylbenzothiazole-2-sulfenamide (DCBS) and/or benzothiazyl-2-sulfenomorpholide (MBS) and/or N-tert-butyl-2-benzothiazylsulfenamide (TBBS).

It is also possible for the rubber mixture to comprise vulcanization retardants.

The sulfur donor substance employed may be selected from any of the sulfur donor substances known to those skilled in the art. When the rubber mixture comprises a sulfur donor substance, this is preferably selected from the group consisting of, for example, thiuram disulfides, for example tetrabenzylthiuram disulfide (TBzTD), tetramethylthiuram disulfide (TMTD) or tetraethylthiuram disulfide (TETD), thiuram tetrasulfides, for example dipentamethylenethiuram tetrasulfide (DPTT), dithiophosphates, for example DipDis (bis(diisopropyl)thiophosphoryl disulfide), bis(O,O-2-ethylhexylthiophosphoryl) polysulfide (e.g. Rhenocure SDT 50®, Rheinchemie GmbH), zinc dichloryldithiophosphate (e.g. Rhenocure ZDT/S®, Rheinchemie GmbH) or zinc alkyldithiophosphate, and 1,6-bis(N,N-dibenzylthiocarbamoyldithio)hexane and diaryl polysulfides and dialkyl polysulfides.

Further network-forming systems as obtainable, for example, under the trade names Vulkuren®, Duralink® or Perkalink® or network-forming systems such as those described in WO 2010/049216 A2 may also be used in the rubber mixture. The latter system contains a vulcanizing agent which crosslinks with a functionality of greater than four and at least one vulcanization accelerator.

During production of the rubber mixture it is preferable to add to this, in the final mixing stage, at least one vulcanizing agent selected from the group consisting of sulfur, sulfur donors, vulcanization accelerators, and vulcanizing agents that crosslink with a functionality of greater than four. This makes it possible to produce from the mixed finished mixture, by vulcanization, a sulfur-crosslinked rubber mixture for use in rubber products, especially in pneumatic vehicle tires.

The terms “vulcanized” and “crosslinked” are used synonymously in the context of the present invention.

The rubber mixture is produced by the process customary in the rubber industry in which a preliminary mixture comprising all constituents apart from the vulcanization system (sulfur and vulcanization-influencing substances) is firstly produced in one or more mixing stages. The finished mixture is produced by adding the vulcanization system in a final mixing stage. The finished mixture is processed further, for example by an extrusion operation, and brought into the appropriate shape. This is followed by further processing by vulcanization, wherein sulfur crosslinking takes place due to the vulcanization system added in the context of the present invention.

The rubber mixture can be used for a wide variety of different rubber products. It may be employed in different components of pneumatic vehicle tires. It is preferably used for the production of pneumatic vehicle tires such as car, van, truck or two-wheeled vehicle tires, where the rubber mixture forms at least the part of the tread that comes into contact with the road.

In a pneumatic vehicle tire, the tread may consist of a single mixture designed in accordance with the invention. It is however commonplace nowadays for pneumatic vehicle tires to have a tread with what is called a cap/base construction. What is meant here by “cap” is the part of the tread that comes into contact with the road, being arranged radially on the outside (upper tread portion or tread cap). What is meant here by “base” is the part of the tread which is arranged radially on the inside, and hence does not come into contact with the road in driving operation, or does so only at the end of the tire lifetime (lower tread portion or tread base). In the case of a pneumatic vehicle tire having such a cap/base construction, at least the rubber mixture for the cap is designed according to claim 1.

The pneumatic vehicle tire of the invention may also have a tread consisting of various tread mixtures arranged alongside one another and/or one on top of another (multicomponent tread).

In the production of the pneumatic vehicle tire, the mixture is brought into the shape of a tread, preferably at least into the shape of a tread cap, as a finished mixture prior to vulcanization, and applied in the known manner in the production of the vehicle tire blank. The tread, preferably at least the tread cap, can also be rolled up in the form of a narrow strip of rubber mixture onto a tire blank.

The invention encompasses all of the advantageous configurations reflected inter alia in the claims. The invention in particular also encompasses configurations that result from combination of different features, for example of constituents of the rubber mixture, with different levels of preference for these features, such that the invention also encompasses a combination of a first feature described as “preferred” or feature described in the context of an advantageous embodiment with a further feature described for example as “particularly preferred”.

The invention will now be illustrated in detail with reference to comparative examples and working examples, which are summarized in Table 1.

The comparative mixtures here are labeled V, the inventive mixture E.

The mixture was produced by the methods customary in the rubber industry under standard conditions in three stages in a laboratory mixer, in which all the constituents apart from the vulcanization system (sulfur and vulcanization-influencing substances) were first mixed in the first mixing stage (preliminary mixing stage). In the second mixing stage the preliminary mixture was mixed again. Addition of the vulcanization system in the third stage (final mixing stage) afforded the finished mixture, which was mixed at 90 to 120° C.

The loss factor tan δ (10%) of the mixture was then determined using an RPA (rubber process analyzer) according to ASTM D6601 from the second strain sweep at 1 Hz, 70° C. and 10% strain in the vulcanized, conditioned state, wherein the test specimens were produced in the apparatus by 10 minute vulcanization under pressure at 170° C.

In addition, all mixtures were used to produce test specimens by vulcanization for 20 minutes under pressure at 160° C., and these test specimens were used to determine material properties typical for the rubber industry by the following specified test methods:
Shore A hardness at room temperature according to ISO 868
rebound resilience at room temperature and 70° C. according to ISO 4662
tensile strength at room temperature according to ISO 37
breaking elongation at room temperature according to ISO 37
maximum loss factor tan δₘₐₓ at 55° C. as the maximum value over the strain sweep from dynamic-mechanical measurement at a frequency of 10 Hz according to ISO 4664-1

The maximum loss factor tan δₘₐₓ at 55° C. (Eplexor) and the loss factor tan δ (10%) by RPA can be correlated with the rolling resistance. A low loss factor tan δₘₐₓ at 55° C. and a low loss factor tan δ (10%) by RPA represent a low rolling resistance. The stress-strain properties, such as tensile strength and breaking elongation, may be correlated with structural durability.

TABLE 1

| Constituents | Unit | 1(V) | 2(V) | 3(V) | 4(E) |
|---|---|---|---|---|---|
| Natural rubber | phr | 10 | 10 | 10 | 10 |
| SSBR^{a} | phr | 90 | 90 | 90 | 90 |
| Liquid BR^{b} | phr | 12.5 | 12.5 | 12.5 | 12.5 |
| Mod. liquid BR^{c} | phr | — | 6 | — | 6 |
| Carbon black | phr | 5 | 5 | 5 | 5 |
| Silica^{d} | phr | 115 | 115 | 115 | 115 |
| AMS resin^{e} | phr | 40 | 40 | — | — |
| Terpene resin^{f} | phr | — | — | 40 | 40 |
| Aging inhibitor | phr | 6 | 6 | 6 | 6 |
| Antiozonant wax | phr | 2 | 2 | 2 | 2 |
| Zinc oxide | phr | 2 | 2 | 2 | 2 |
| Stearic acid | phr | 1 | 1 | 1 | 1 |
| Processing auxiliary | phr | 6 | 6 | 6 | 6 |
| Silane coupling agent^{g} | | 8.2 | 8.2 | 8.2 | 8.2 |
| Accelerator | phr | 3.7 | 3.7 | 3.7 | 3.7 |
| Sulfur | phr | 1.6 | 1.6 | 1.6 | 1.6 |
| Properties | | | | | |
| Shore A hardness at RT | Shore A | 68.0 | 64.8 | 66.5 | 61.9 |
| Rebound resilience at RT | % | 17.4 | 19.7 | 18.6 | 21.1 |
| Rebound resilience at | % | 42.4 | 44.7 | 41.7 | 44.5 |
| 70° C. | | | | | |
| Tensile strength at RT | MPa | 17.6 | 16.9 | 15.4 | 16.7 |
| Breaking elongation at | % | 639 | 619 | 646 | 712 |
| RT | | | | | |
| tan δₘₐₓ at 55° C. | — | 0.244 | 0.225 | 0.251 | 0.227 |
| tan δ (10%) by RPA, | — | 0.195 | 0.183 | 0.212 | 0.193 |
| cured, cond. | | | | | |

^{a}Sprintan ® SLR-3402, Trinseo, functionalized, solution-polymerized styrene-butadiene copolymer with functionalization for the polymer/silica and the polymer/carbon black interaction, T_{g} = −62° C.
^{b}LBR−302, Kuraray, liquid polybutadiene, T_{g} = −85° C.
^{c}Polyvest ® EP ST-E 60, Evonik, terminally triethoxysilane-modified liquid polybutadiene, Tg = −80° C., average molar mass M_{w} about 13 600 g/mol (GPC, polybutadiene standard)
^{d}ZEOSIL ® 1165 MP, Solvay S.A., BET surface area = 155 m²/g (measured with nitrogen), CTAB surface area = 156-157 m²/g;
^{e}Sylvatraxx ® 4401, Kraton Chemicals SAS, alpha-methylstyrene resin, softening point = 85° C. (according to ASTM E 28), T_{g} = 45° C.
^{f}Sylvatraxx ® 8115, Kraton Chemicals SAS, non-limonene based terpene resin, softening point = 115° C. (according to ASTM E 28), T_{g} = 66° C.
^{g}3,3′-bis(triethoxysilylpropyl)disulfide (TESPD)

It is apparent from the data in table 1 that the combined presence of the terpene resin based to an extent of more than 95% on biologically renewable raw materials with a liquid polybutadiene which is organosilicon-modified and has an average molecular weight M_{w} by GPC of 13 600 g/mol has the result that in mixture 4(E) the stress-strain properties tensile strength and breaking elongation are improved, i.e. increased, surprisingly to an extent that goes far beyond the expected effect of the individual measures (addition of modified polybutadiene 2(V) alone and replacement of the alpha-methyl-styrene resin by terpene resin 3(V) alone). Mixture 4(E) accordingly has a high structural durability. The maximum loss factor tan δₘₐₓ at 55° C. and the tan δ (10%) by RPA are also significantly improved, i.e. reduced, in mixture 4(E) which leads to a reduced rolling resistance in the treads of pneumatic vehicle tires.

1. A sulfur-crosslinkable rubber mixture, especially for the tread of pneumatic vehicle tires, containing at least the following constituents:
at least one diene rubber,
5 to 70 phr (parts by weight based on 100 parts by weight of all rubbers in the mixture) of at least one terpene resin based to an extent of more than 95% on biologically renewable raw materials,
1 to 40 phr of at least one liquid polybutadiene which is organosilicon-modified and has an average molecular weight M_{w} by GPC of 500 to 18 000 g/mol and
40-350 phr of at least one filler.

2. The sulfur-crosslinkable rubber mixture as claimed in claim 1, wherein that it contains 20 to 60 phr, preferably 30 to 50 phr, of at least one terpene resin based to an extent of more than 95% on biologically renewable raw materials.

3. The sulfur-crosslinkable rubber mixture as claimed in claim 1, wherein that the terpene resin is based to an extent of 100% on biologically renewable raw materials.

4. The sulfur-crosslinkable rubber mixture as claimed in claim 1, wherein that the terpene resin is not based on limonene.

5. The sulfur-crosslinkable rubber mixture as claimed in claim 1, wherein that the terpene resin is based on α- and β-pinene.

6. The sulfur-crosslinkable rubber mixture as claimed in claim 1, wherein that the terpene resin has an average molecular weight M_{w} by GPC of 800 to 1500 g/mol.

7. The sulfur-crosslinkable rubber mixture as claimed in claim 1, wherein that the terpene resin has a softening point of 100° C. to 140° C., preferably 110° C. to 130° C.

8. The sulfur-crosslinkable rubber mixture as claimed in claim 1, wherein that the terpene resin has a glass transition temperature Tg of 50° C. to 100° C., preferably of 50° C. to 80° C.

9. The sulfur-crosslinkable rubber mixture as claimed in claim 1, wherein that it contains 2 to 17 phr of the liquid polybutadiene which is organosilicon-modified.

10. The sulfur-crosslinkable rubber mixture as claimed in claim 1, wherein that the liquid polybutadiene is organosilicon-modified terminally and/or along the chain.

11. The sulfur-crosslinkable rubber mixture as claimed in claim 10, wherein that the liquid polybutadiene which is organosilicon modified is terminally modified with a triethoxysilane group.

12. The sulfur-crosslinkable rubber mixture as claimed in claim 1, wherein that the liquid polybutadiene which is organosilicon-modified has a glass transition temperature T_{g} by DSC of −85° C. to −30° C.

13. The sulfur-crosslinkable rubber mixture as claimed in claim 1, wherein that it contains 20 to 200 phr of silica as filler.

14. A pneumatic vehicle tire comprising at least one component made of a sulfur-vulcanized rubber mixture as claimed in claim 1.

15. The pneumatic vehicle tire as claimed in claim 14 having a tread, at least the roadway-contacting portion of which is made of the sulfur-vulcanized rubber mixture.
